(19) United States
(12) Patent Application Publication
(10) Pub. No.: US 2006/0063676 A1
(43) Pub. Date: Mar. 23, 2006

(54) Method for enhancing deposition of an agrochemical

(76) Inventors: Mickey R. Brigance, Germantown, TN (US); Greg M. McManic, Memphis, TN (US); Patrick M. McMullan, Memphis, TN (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/943,790

(22) Filed: Sep. 17, 2004

(51) Int. Cl. A01N 25/00

(52) U.S. Cl. 504/116.1

(57) ABSTRACT

A method for enhancing the deposition of an agrochemical onto an agricultural substrate by applying a sufficient amount of an aqueous microemulsion of an agrochemical and a surface active agent by an air induction spray.

### INTRODUCTION AND BACKGROUND

The present invention relates to enhancing the deposition of an agrochemical onto an agricultural substrate.

For the purpose of enhancing or modifying the chemical and/or physical characteristics of agrochemicals in general, selected substances are added to the agrochemical to form spraying formulations. Generally referred to as adjuvants, these substances have no substantial pesticidal or herbicidical activity of their own. Since spray application can be critical to the performance of the agricultural chemical, adjuvants are added to reduce problems that frequently occur in the application thereof to agricultural substrates such as crops and soil. Issues relating to chemical stability, incompatibility, solubility, suspension, foaming, drift, evaporation, volatilization, phytotoxicity, surface tension, droplet size and coverage are common subjects of concern. Depending on their type, adjuvants can enhance wetting, spreading, sticking, emulsifying, dispersing and biological activity. Adjuvants include wetting agents, crop oil concentrates, spreaders, stickers, buffering agents, foaming and anti-foaming agents, dispersing agents and drift control agents. Over 200 EPA-registered pesticides have specific recommendations on their labels for adjuvant use. These are recommended to enhance biological activity of the pesticide and to reduce, minimize or eliminate spray application problems. To achieve consistent, effective results from adjuvants, one must first select the desired type of adjuvant and then the appropriate product within that specific type for use with a particular pesticide or herbicide and then use that product at recommended rates.

It is known that petroleum hydrocarbon spray oils increase the efficacy of herbicides, fungicides and other pesticides by enhancing the deposition characteristics and wetting and spreading of the spray solution. These materials typically result in a more even and uniform spray deposit on the crops or soil or by increasing the biological effect of the applied agrochemical. Other oils such as esterified vegetable oils and once-refined vegetable oils are known to exhibit similar properties. Such spray oils can increase penetration and slow evaporation. Paraffin based spray oil is a petroleum oil used as dormant spray, summer oil, carrier for pesticides or an adjuvant to increase the efficacy of agricultural chemicals.

The prior art is aware of agricultural spray oil compositions containing a major amount of petroleum oil and a minor amount of a vegetable oil as a carrier, which enhances the effectiveness of selective herbicides.

A herbicidal composition said to be synergistic is disclosed in U.S. Pat. No. 4,755,207 and comprises a non-phytotoxic crop oil, a surfactant, and hydrophobic mycoherbicide spore. The oils are once refined vegetable oils or highly refined paraffinic material. The surfactant can be anionic, cationic or nonionic. A surfactant containing a solvent having a high aromatic content above 95%, which corresponds to a very low UR value are also known.

Some applications require the separate addition of buffering agents to adjust the pH of alkaline waters used to make up the spray solutions. The buffering agents regulate solution pH to avoid hydrolysis of pesticides that tend to decompose in alkaline spray solutions. Generally, the pH of the spray should be adjusted to be in a range of 4 to 6 or slightly acidic. Known buffering agents include alkylaryl polyethoxyethanol phosphates and organic phosphorous acids as the principal functioning agents. Typically, such a buffering agent is added to the water, which is then combined with the pesticide, and any other adjuvants required.

Aqueous lower alkanol solutions containing alkylaryl polyoxethyleneglycol-phosphate esters, which are as compatibility agents for mixtures of liquid fertilizer and pesticides are known. Such solutions contain about 20% methanol, about 16% water and about 64% of the phosphate ester.

A biocidal fine powder and an agricultural suspension containing the fine powder and an adjuvant are disclosed in U.S. Pat. No. 4,851,421. The adjuvant can be a polyoxyalkylene-type nonionic surface-active agent or polyoxyalkylene alkyl or alkylaryl ether phosphates or their salts. The composition does not include any oil components.

U.S. Pat. No. 6,255,253 defines a microemulsion size and has background information on adjuvants. This patent illustrates the type of microemulsions that can be used in accordance with this invention. The microemulsions described therein are emulsions of the oil-in-water type. They are optically isotropic, thermodynamically stable systems, which contain water-insoluble oils, emulsifiers and water. The clear or transparent appearance of the microemulsions is attributable to the small droplet size of the dispersed oils which is essentially below 300 nm, i.e., more than 50% and preferably more than 80% of the droplets are below 300 nm in size, fine-droplet microemulsions brown-red in transmitted light and a shimmering blue in reflected light being present in the range from 100 to 300 nm and substantially optically clear microemulsions being present in the particularly preferred range of 10 to 100 nm. The optical impression of the clear transparency is particularly good when the transmissivity of the emulsion for light with a wave length of 650 nm is at least 85%. The microemulsions are stable over a broad temperature range of 0 to 50° C. Proportions of components making up microemulsions can vary widely as will be understood by persons skilled in the art. Also, various well known methods can be used to prepare the microemulsions suitable for this invention.

U.S. Pat. No. 6,432,884 discloses compositions useful as adjuvants for agricultural chemical formulations composed of a lower alkanol ester of a fatty acid and an emulsifier component. The emulsifier can be a nonionic surfactant such as an ethoxylated castor oil, an alkoxylated castor oil, an ethylene-propylene block copolymer, an ethoxylated-propoxylated alkyl phenol, an ethoxylated sorbitan fatty acid ester, a sorbitan fatty acid ester and an anionic surfactant such as an ethoxylated partial phosphate ester, alkyl sulfate, an alkyl ether sulfate, a branched alkyl benzene sulfonate, a linear alkyl benzene sulfonate and an alpha olefin sulfonate. Such adjuvants exhibit good electrolyte tolerance and are stable to hard water when used in combination with fertilizers.

U.S. Pat. No. 4,997,642 discloses oil-in-water emulsions containing polyvinyl alcohol, surfactant and a salt with improved freeze-thaw and elevated temperature storage stability.

### SUMMARY OF THE INVENTION

The deposition of agrochemicals onto an agricultural substrate such as a crop, vegetation or soil can be made more effective if the agrochemical is present in a microemulsion and by applying the microemulsion by air induction nozzle.

More particularly, a method for applying an agrochemical in the form of a transparent oil-in-water microemulsion using an air induction nozzle is provided by the present invention. Typically the droplet size of the microemulsion is above 10 to 100 nm and contains at least one surface active agent as emulsifier. Optionally other auxiliaries and additives can be present. Generally the oil phase of the microemulsion contains a water-insoluble agrochemical and optionally other organic or inorganic water-insoluble or sparingly soluble additives.

### BRIEF DESCRIPTION OF DRAWING

The present invention will be further understood with reference to the accompanying drawing which is a schematic cross sectional view of a typical air induction nozzle that can be used in accordance with the present invention.

### DETAILED DESCRIPTION OF THE INVENTION

As described herein the microemulsions are oil-in-water microemulsions. They are transparent and stable systems which contain water-insoluble or partially soluble components oils, surface active agents and water. The clear or transparent appearance of the microemulsions is attributable to the small droplet size of the dispersed materials which is essentially 50% in the range from 100 to 300 nm and substantially optically clear microemulsions being present in the particularly preferred range of 10 to 100 nm. The microemulsions according to the invention are stable over a broad temperature range of 0 to 50° C. The pH of the microemulsion can range from 2 to 10.

The microemulsions suitable for prognosis of the invention are containing as oil phase the water-insoluble or partially soluble agrochemical. The agrochemical concentrates according to the invention contain the oil phase, i.e. agrochemical, and optionally other solvents, auxiliaries and additives soluble or dispersible in the oil phase which are commonly used in the art. These optimal ingredients make up preferably 10 to 50% by weight. The surface active agent makes up the balance of the total adjuvant present.

As the term is used herein, “agrochemicals” are substances which can be used for plant protection such as typical pesticides, but also include herbicides and fertilizers. Agrochemicals also include insecticides, acaricides, nematicides, pesticides and also repellents or rodenticides, sexual attractants, mammal and bird repellents and chemosterilants as are well known in the art. See, for example, in Chemie der Pflanzenschutz- und Schädlingsbekämp-fungsmittle, Vol. 1, Editors: R. Wegler, Springer-Verlag Berline, 1970 and in The Pesticide Manual, World Compendium: 8^{th} Edition, The British Crop Protection Counsel, 1987. The agrochemicals are typically insoluble or sparingly soluble in water. In the present context, this means a solubility in water at room temperature (21° C.) of less than 10% by weight and preferably less than 5% by weight. Many important agrochemicals have a solubility in water of less than 1% by weight. The agrochemicals may be solid or liquid at room temperature and may contain mixtures of water-insoluble agrochemicals in any quantity ratios. They may also contain water-soluble compounds. Fertilizer can be present in the amount of 0.0001 to 99% by weight of the spray mixture containing the microemulsion.

The microemulsion compositions used according to the method of this invention are particularly useful when the water-insoluble oil is a pesticide. “Pesticide” includes insecticides, herbicides, plan growth regulators and fungicides. Insecticides include, for example, the well known malathion, fentrothion, dimethoate, fluvalinate, permethrin, cypermethrin, fenvalerate, deltamethrin and fenpropathrin. Herbicides include, for example, glyphosate.

The herbicide compositions containing the adjuvant compositions of the present invention include, but are not limited to, glyphosate, triazines, (such as atrazine or simazine), anilines, (such as trifluralin and pendimethalin), anilides, (such as propanil), phenoxys, (such as 2.4-D), oximes, (such as sethoxydim). The insecticide compositions containing the adjuvant compositions of the present invention include, but are not limited to, organophosphates, (such as dimethoate and methyl parathion), carbamates, (such as carbaryl), and pyrethroids, (such as cyfluthrin and cypermethrin). The fungicide compositions containing the adjuvant compositions of the present invention include, but are not limited to, phthalamides, (such as captan), and conazoles, (such as propiconazole).

The surfactants suitable for use in the microemulsions of this invention include anionic, cationic, non-ionic and amphoteric surfactants and compatible mixtures thereof. Surfactants suitable for use in the formulation of the present invention are, for example, blended surfactants which are designed by the manufacturer specifically for use in emulsifible concentrates of synthetic organic pesticides. These surfactants are believed to be blends of common anionic and non-ionic surfactants with the most functionally significant component being alkali or alkaline earth alkaryl sulfonate, such as calcium dodecylbenzene sulfonate. Examples include TOXIMUL D (Stephan Chemical); TRITON AG-180, AG-190 or AG-193 (Rohm & Haas); the ATLOX series (Imperial Chemical Industries); and the SPONTO series (Witco).

Another class of surfactants suitable for use in the microemulsions of the present invention are sodium naphthalene formaldehyde condensates. Examples of such surfactants are PETRO DISPERSANT 425 (Petro Chemicals Co., Inc.), BLANCOL N (GAF) and TAMOL N (Rohm & Haas).

Non-ionic surfactants suitable for use in the present invention include surfactants such as TRITON CF-21 (Rohm & Haas), a modified ethoxylated non-ionic surfactant. Amphoteric surfactants such as DERIPHAT BAW (Henkel), cocoamidoebetaine and LONZAINE 10S and 12C (Lonza, Inc.), decylbetaine and cocobetaine can also be used in the microemulsions of this invention. Examples of suitable cationic surfactants include ETHOMEEN C-15 and T-15 (Industrial Chemical Division of Armac, Inc.), tertiary amine-ethylene oxide condensation products of primary fatty amines, tallow amines and cocoamines. The preferred surfactants are the anionic and the amphoteric surfactants. Generally, the content of surfactant is from 0.0001 to 10% by weight of a spray mixture containing the microemulsions.

In preparing the microemulsions suitable for use in the method of the invention, the vegetable oils can be used. These include, but are not limited to vegetable seed oil or a mixture of vegetable seed oils, as they are known in the agricultural industry, crop seed oils which are produced from the particular crop from which their name is derived. Included in the vegetable oils suitable for the present invention are cotton seed oil, canola, rapeseed, peanut oil, sunflower oil, linseed oil, safflower oil, soybean oil, corn oil, olive oil, coconut oil, tall oil or other seed oils and blends of the above oils such as cotton seed oil plus soybean oil; cotton seed oil plus peanut oil; cotton seed oil plus olive oil; corn oil plus linseed oil; corn oil plus soybean oil; as well as blends of any two or more of the above disclosed vegetable oils. The vegetable oils can be present in an amount from about 1 to about 99%, preferably from about 50 to about 99% and most preferably from about 80 to about 99% of the adjuvant composition.

Additionally, the spray oil used in the microemulsions of this invention can also optimally contain agricultural spray oils which are petroleum hydrocarbon oils. These spray oils are the refined fraction of petroleum oil and the preferred petroleum oil is a paraffin oil which is a blend of C₁₀-C₁₈ saturated aliphatic hydrocarbons. Spray oils can be characterized by specifications such as unsulfonated residue, API-gravity, distillation range and pour point. A high unsulfonated residue (UR) indicates a minimum of reactive material in the spray oil and the degree of refinement thereof. This UR value corresponds to about 100% minus the aromatic content. Kerosine, coal oil, naphtha and diesel fuel are all phytotoxic and exhibit low UR values due to their reactivity and therefore, they all have a high aromatic content. Paraffinic oils that have high UR values exhibit little or no phytotoxicity. A minimum of 92% UR is typically required for agricultural spray oils. A spray oil with a 31-34 API gravity indicates a high degree of paraffinic oil content. An API gravity value of 23 or less indicates an oil with aromatic and napthenic constituents. As a result, such oils are more reactive and phototoxic. The distillation range determines physical properties of spray oils. Also, a high boiling range is an indication of an oil's phytotoxicity. Lower boiling ranges indicate that the oil has an increased evaporation rate and lower tenacity.

The microemulsion formulations of the present invention containing pesticidally active components are concentrates. Before normal use, these concentrates are diluted with water to a concentration providing from 0.01 to 0.1 weight percent of the active ingredient. Therefore, the ability of the composition to disperse easily in water is critical.

### EXAMPLES

The following examples are suitable adjuvant formulations that can be used to prepare microemulsions:

| | |
|---|---|
| Raw Material | % |

A. Formula

| | |
|---|---|
| Paraffinic Hydrocarbon Solvent | 60.0 |
| Alkyl Aryl Ethoxylate Phosphate | 5.0 |
| Amino Ethyl Ethanol Amine | 0.35 |
| Alkyl Aryl Ethoxylate POE 6 | 4.0 |
| Ethoxylated sorbitan monooleate POE 20 | 16.45 |
| Ethoxylated C6-12 alcohol POE 2 | 13.0 |
| Defoamer | 0.2 |
| Water | 1.0 |
| Total | 100.0 |

B. Formula

| | |
|---|---|
| Alkyl Aryl Ethoxylate POE 6 | 2.72 |
| Alkyl Aryl Ethoxylate POE 9 | 3.06 |
| Distilled Tall Oil Fatty Acid | 10.45 |
| Paraffinic Hydrocarbon Solvent | 83.0 |
| Water | 0.68 |
| Total | 100.0 |

C. Formula

| | |
|---|---|
| C 18 methyl soyate | 85.0 |
| Alkyl Aryl Ethoxylate POE 6 | 10.0 |
| Alkyl Aryl Ethoxylate POE 9 | 5.0 |
| Total | 100.0 |

D. Formula

| | |
|---|---|
| C 18 methyl soyate | 80.0 |
| Alkyl Aryl Ethoxylate POE 6 | 5.0 |
| Polyether-polymethylsiloxane-copolymer | 15.0 |
| Total | 100.0 |

E. Formula

| | |
|---|---|
| C 18 methyl Rapeate | 19.2 |
| Water | 38.5 |
| Citric Acid 50% | 0.28 |
| Glycerol Monooleate | 8.4 |
| C8-10 Alkyl Polyglycoside | 33.62 |
| Total | 100.0 |

F. Formula

| | |
|---|---|
| 32% Nitrogen | 58.5 |
| C8-10 Alkyl Polyglycoside | 1.5 |
| Water | 3.0 |
| Phosphate ester of TriDecyl alcohol | 8.2 |
| C 18 methyl soyate | 10.7 |
| Ethoxylated Castor, POE-16 | 14.8 |
| Polyether-polymethylsiloxane-copolymer | 2.5 |
| Defoamer | 0.1 |
| Amino Ethyl Ethanol Amine | 0.7 |
| Total | 100 |

Air Entrapment Definition:

The key characteristic of sprays produced from air induction nozzles is the entrapment of air (air bubbles) in the spray droplets. The air bubbles affect droplet size and droplet velocity and therefore droplet impaction and spray retention on the target surfaces. The air bubbles in the spray droplet tend to reduce the density of the droplet and improve droplet impaction and spray retention on target surfaces compared to droplets of similar size that do not contain air.

Nozzels Types

Suitable nozzles for purposes of the present invention include the Hardi InJet 11001 nozzles manufactured by Hardi International, Davenport, Iowa 528056. Air induction nozzles are known in the art as shown for example in U.S. Pat. No. 5,765,761, U.S. Pat. No. 4,004,733 and U.S. Pat. No. 5,975,425.

The only type of air induction nozzle used in standard agricultural practices can be classified as containing a venturi device, which is designed into the nozzle body. These are small inlets in the side of the body of the nozzle that allows air to be injected into the stream of liquid passing over the inlet. The air entrapped in the liquid lowers the spray pressure within the nozzle body, and also air is entrapped within the spray solution, which lowers the density of the sprayed solution. The result of the entrapped air improves droplet impaction and spray retention on target surfaces. Air induction nozzles minimize fine droplets. Hence, undesired drift is reduced.

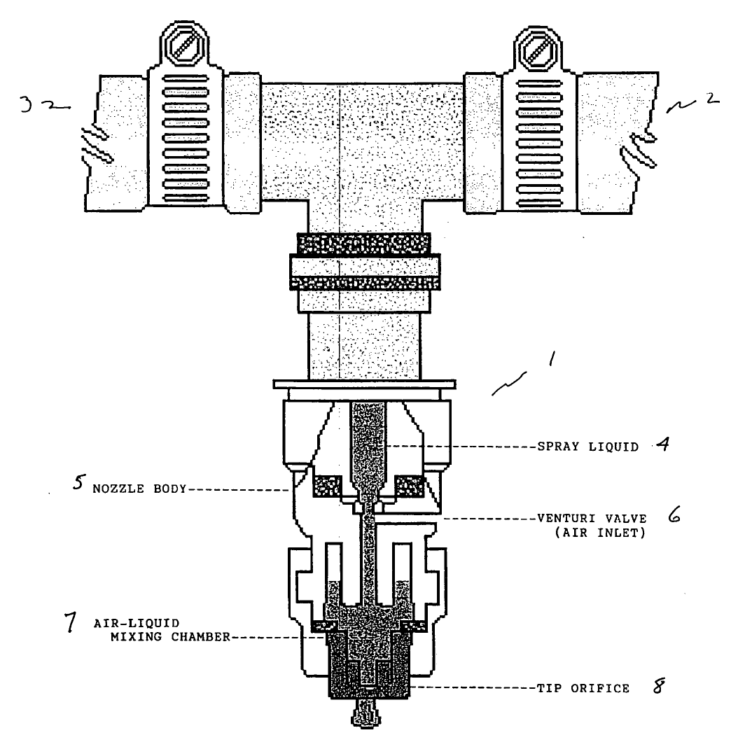

FIG. 1 shows a schematic cross sectional view of a typical nozzle (1) of the air induction type showing feed lines 2, 3 for feeding components of the spray. The spray liquid 4 then passes through nozzle body 5. Air inlet 6 introduces air to create a venturi jet effect. The air-liquid mixture is mixed in the mixing chamber 7 of the valve body. The spray exits at the tip orifice 8 to contact the intended plant, crop or soil with the desired agrochemical composition.

Further variations and modifications of the foregoing will be apparent to those skilled in the art and are intended to be encompassed by the claims appended hereto.

We claim:

1. A method for enhancing the deposition of an agrochemical onto an agricultural substrate comprising:
applying thereto a sufficient amount of an aqueous microemulsion of an agrochemical and a surface active agent by an air induction spray.

2. A method for increasing the amount of air entrapped in a spray of an agrochemical comprising:
spraying a microemulsion of an agrochemical and surfactant through an air induction nozzle.

3. A method for treating an agricultural substrate comprising:
contacting said substrate with an agrochemical composition containing an agrochemical microemulsion and water by spraying said microemulsion using an air induction nozzle.

4. The method of claim 1, wherein the microemulsion contains a herbicide, a crop oil or vegetable oil in addition to said surfactant.

5. The method according to claim 1, wherein the surfactant is present in the amount of 0.0001 to 10% by weight of a spray mixture containing said microemulsion.

6. The method according to claim 1, wherein a fertilizer is present in the amount of 0.0001 to 99% by weight of a spray mixture containing said microemulsion.

7. The method according to claim 1, wherein the pH of the microemulsion is from 2 to 10.

8. The method according to claim 1, wherein the microemulsion and water are present in a weight ratio of 1:10 to 1:2000.

9. A method for treating an agricultural substrate in the form of vegetation or soil comprising:
providing an agrochemical composition in the form of a microemulsion containing an agrochemical, water, a surfactant and at least one of a vegetable oil, modified vegetable oil, modified natural oil and a paraffin oil
applying said agrochemical composition to said substrate by spraying a sufficient amount of said composition onto said substrate by air induction spray means.

10. The method according to claim 9, wherein said microemulsion further contains a defoamer.
